(19) United States
(12) Patent Application Publication
(10) Pub. No.: US 2005/0162057 A1
(43) Pub. Date: Jul. 28, 2005

(54) Cathode ray tube with improved, stackable interal magnetic shield

(76) Inventor: Franciscus Henricus Josephus Simkens, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,455

(22) PCT Filed: Apr. 29, 2003
(86) PCT No.: PCT/IB03/01738

(30) Foreign Application Priority Data
May 24, 2002 (EP) 02077049.1

(51) Int. Cl. H01J 29/80

(52) U.S. Cl. 313/402

(57) ABSTRACT

A ferromagnetic shielding funnel for reception within the conical portion of a cathode ray tube having support members at the corner portions of its wider end. The support members project over a small distance into the inner space of the funnel for forming reference faces. The funnel has indentations so that, when two funnels are stacked one upon the other, the indentations in the lower funnel receive the inwardly projecting portions of the support members of the upper funnel, so that damage during and after stacking is prevented.

The invention relates to an Internal Magnetic Shield for a cathode ray tube, having a cone portion with two long sides and two short sides, and a flange at the wider end of the cone portion, the flange having four corner portions, each corner portion being bevelled, a metal support member being arranged at each of said corner portions, each metal support member comprising a base plate which is attached to the side of the flange which is remote from the cone portion and a distal end having an aperture.

The invention further relates to a cathode ray tube equipped with such an internal magnetic shield.

CRTs for color television, computer monitors and other display applications rely on a cathodoluminescent phosphor screen to provide a visible display. Such a screen is composed of a repetitive pattern of a large number of small red, blue and green-emitting phosphor elements, which are excited to luminescence by electron beams emanating from an electron gun behind the screen. There are three beams, i.e. one for each of the red, blue and green components of a color display signal. In operation, the screen is repetitively scanned by the three beams simultaneously, while the intensities of the beams are modulated by the respective individual primary color components of the display signal. The large number of phosphor elements, together with the scanning frequency, results in the perception of a steady, full color display by a viewer.

Such CRTs typically employ a color selection means, like a shadow mask. A shadow mask is a thin sheet having a large number of apertures and mounted between the phosphor screen and the electron gun, a short distance behind the screen. The apertures are aligned with the phosphor elements on the screen and the electron beams are directed from the electron gun to converge at the mask. When the beams pass through the individual apertures, they diverge from one another to land on the phosphor element of the corresponding color.

The mask, which is typically 0.15 to 0.25 mm thick, is supported on a frame to maintain its shape. This frame is then securely mounted in the glass envelope in order to maintain the mask in proper registration with the screen. Such registration must not only be maintained in the X and Y directions, but also in the Z direction, i.e., along the tube axis in order to insure that the beams do not land on adjacent phosphor elements, which would degrade the color purity of the display image.

Particularly during the warm-up period, the mask heats up and expands in all directions. Once the frame also warms up, the thermal compensation effect of the suspension system takes place, moving the whole mask closer to the screen, and maintaining overall color purity by bringing all of the mask apertures back into the electron beam path. When the temperature differential between the mask and frame is large during initial warm-up, the time required for thermal compensation is longer. This differential is minimized by using a frame of as low a mass as possible.

A common technique to maintain the proper Q space (distance between mask and screen) during tube warm-up has been to employ a so-called “corner lock” suspension system, in which corner lock mechanisms, each of which include thermal compensation means, are attached to the four corners of the frame.

A current Philips mask suspension system is described in an article by Robert Donofrio entitled “Comer Lock Suspension” in the November 1995 issue of Information Display. This system employs corner brackets welded to lightweight diaphragm strips to form a rectangular frame; each diaphragm strip has an angular cross section formed by a base section and an upright section to which the shadow mask is welded. A resilient plate, also referred to as a temperature compensating plate or as a hinge plate, is fixed to each corner plate by a spring which loads it toward a pin embedded in a corner of the skirt adjacent to the face plate. The pin is engaged by a floating washer mounted to the hinge plate. During assembly, the floating washers are welded to the hinge plates after the mask/frame assembly is engaged to the pins. The phosphor elements are then applied in a photo-lithographic screening process, which involves removing and replacing the assembly several times. After a conductive coating is applied to the phosphor elements, the assembly is fixed in place by welding the floating washers to the studs. The Internal Magnetic Shield (IMS) is fixed in the vacuum envelope independently by separate support members which are welded to the studs over the frame assembly.

However, it is difficult to attach (weld) the support members in such a manner to the Internal Magnetic Shield that the apertures in their distal ends engage the studs during the mounting process. To solve this problem, according to the invention the Internal Magnetic Shield of the type described in the preamble has a metal support member with a base plate which has a portion which projects into the inner space of the cone portion. The inwardly projecting plate portion can be used to position the base plate, and thus the support member, before welding. Preferably the inwardly projecting portion of at least one base plate comprises at least one reference face, said reference face extending normal to the main surface of the base plate. The presence of such reference faces simplifies the accurate positioning of the metal support members.

However, internal magnetic shields have to be stacked during storage and transportation. It turns out that some of the inventive internal magnetic shields, after de-stacking and mounting in a CRT, do not present the desired magnetic shielding properties.

Detoriation of the magnetic shielding properties can detoriate color reproducibility, such as color unevenness or color difference, of displayed images in the whole region of the screen by introducing mislanding due to magnetic field components in the axial direction of the tube.

According to the invention this problem is solved by the use of an Internal Magnetic Shield the cone portion of which has four corners where the long sides and the short sides cross, an indentation being provided in each corner, each indentation having a flat bearing surface at the sides where it faces the flange, said bearing surfaces enabling the inwardly extending portions of the base plates of the support members of another Internal Magnetic Shield, if stacked on the Internal Magnetic Shield, to rest on them. The invention relates in particular to shields formed by deep drawing. Such shields present wrinkles in their corner areas. These wrinkles consist of “superfluous” material, which in the framework of the invention is used to form, inwardly projecting, indentations.

The above solution is based on the insight that during stacking of a plurality of inner magnetic shields the inwardly projecting portions of the base plates of the support members can locally exert clamping forces which deform the cone portions. Moreover, when the inner magnetic shields are de-stacked, and a plurality of them are clamped to each other, twisting of the inner magnetic shields can occur, which also causes deformation of the cone portions.

In this connection it should be noted that in an annealing step the inner magnetic shields have been given optimum magnetic (shielding) properties in a previous stage of the manufacture. Any deformation which occurs after annealing has a disadvantageous influence on the magnetic properties which cannot be restored.

The indentations in the corners of the Internal Magnetic Shield are formed such that they provide bearing faces for the support members of another Internal Magnetic Shield if stacked on the Internal Magnetic Shield. By this measure clamping and twisting is avoided, so that no deformation occurs and the magnetic shielding properties are not deteriorated.

According to a further embodiment the indentations in the corners are arranged at such positions that if another Internal Magnetic Shield is stacked on the Internal Magnetic Shield the distance between their flanges is in the range from 5 to 20 mm.

The spacing between the flanges of adjacent inner magnetic shields in a stack of inner magnetic shields which have inwardly projecting support members, but no indentations at the corners, is e.g. in the range from 25 to 50 mm, depending on the steepness of the cone portion and the degree to which the support member projects inwardly. By arranging the indentations and bearing faces of the inventive Internal Magnetic Shield properly, the spacing between the flanges of adjacent shields (the stacking period) can be much smaller, enabling more compact stacking.

The invention also relates to a CRT equipped with an Internal Magnetic Shield as described above.

According to a first embodiment said CRT has a shadow mask mounted on pins, the Internal Magnetic Shield is mounted through its support members on the same pins, the mounting being directly or indirectly.

Some embodiments of the invention will be described hereafter, with reference to the drawing, in which:

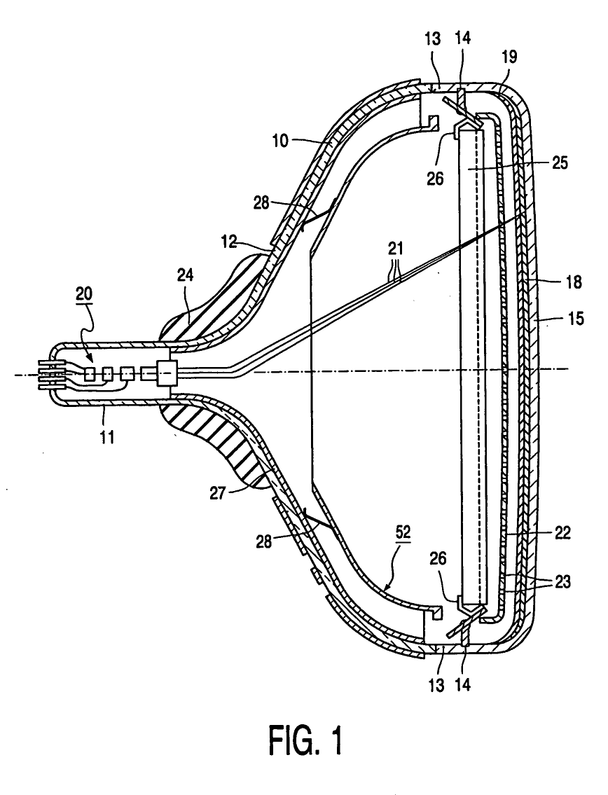

FIG. 1 is a sectional view of a cathode ray tube;

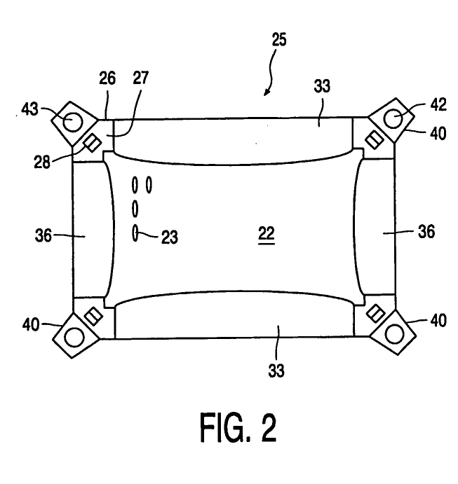

FIG. 2 is a plan view of the supporting frame and mask, seen from the rear;

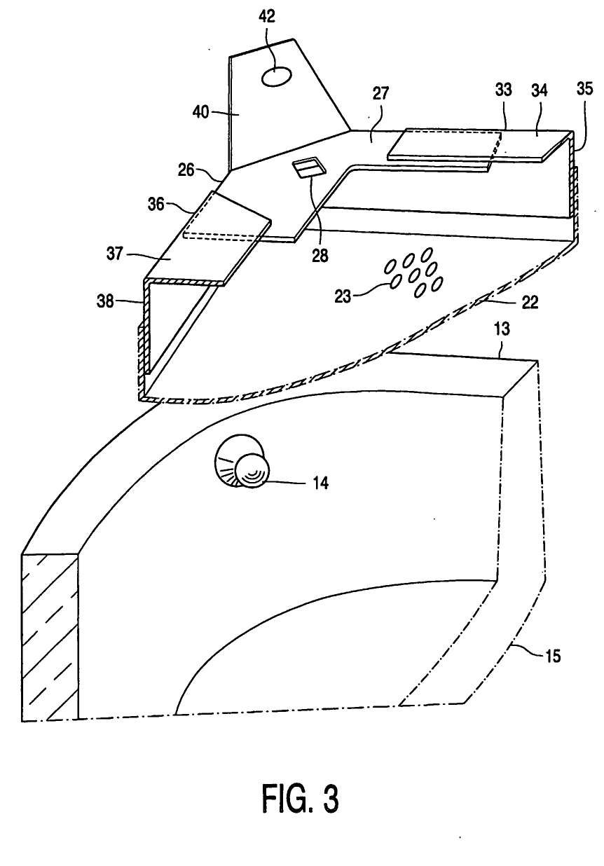

FIG. 3 is a partial perspective view of the corner bracket, frame, and mask exploded from the face plate;

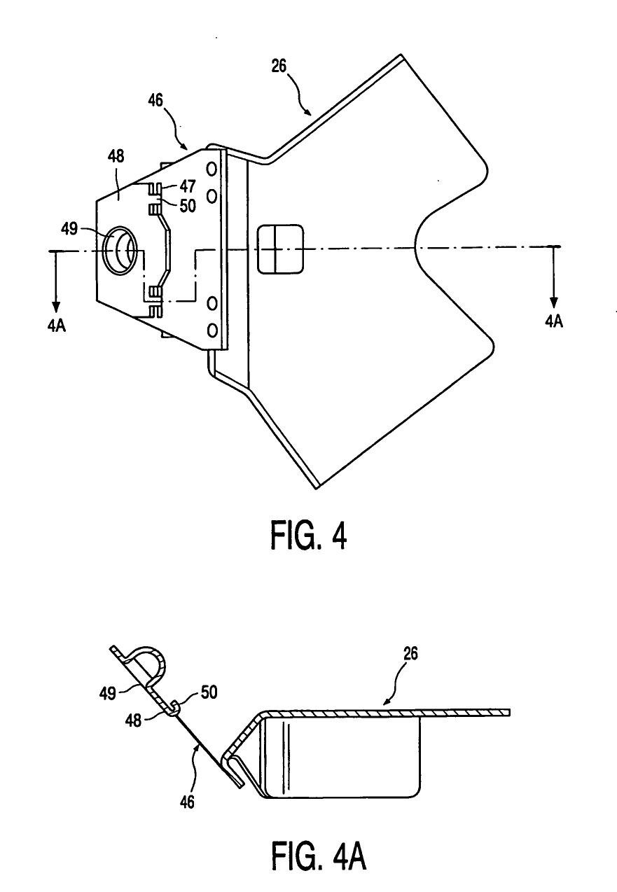

FIG. 4 is a plan view of a corner bracket and an embodiment of a temperature compensating plate;

FIG. 4A is a sectional view taken along line 4A-4A of FIG. 4;

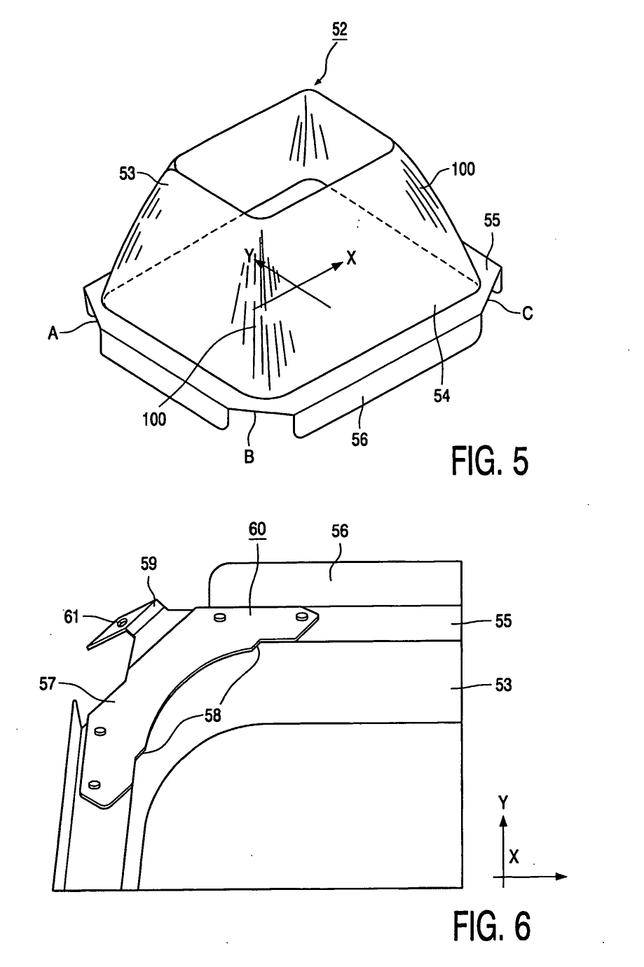

FIG. 5 is a perspective view of an Internal Magnetic Shield;

FIG. 6 shows a support member mounted in the corner of an Internal Magnetic Shield;

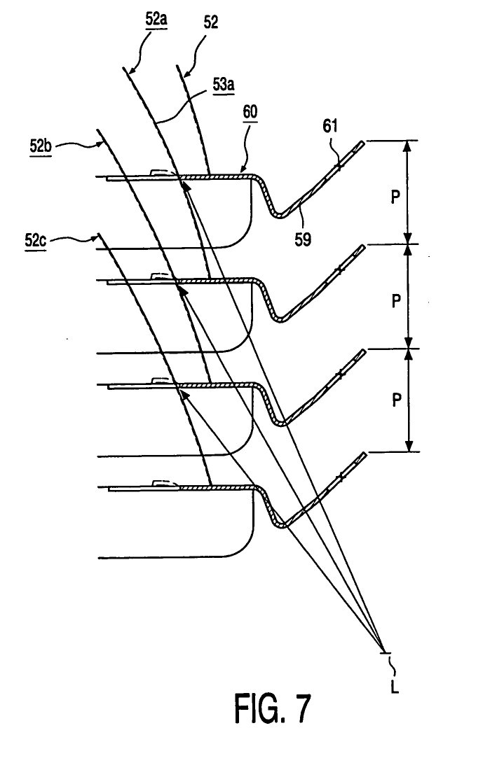

FIG. 7 schematically shows the stacking of a plurality of Internal Magnetic Shields of the FIG. 6 type;

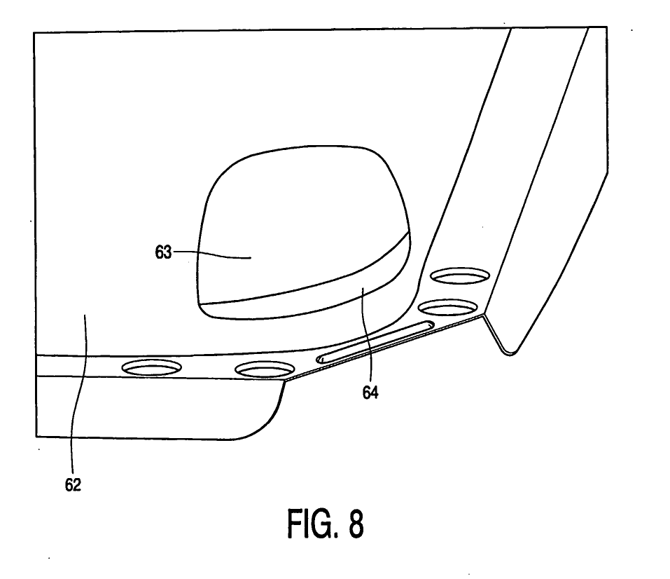

FIG. 8 shows a corner portion of an embodiment of an inventive Internal Magnetic Shield;

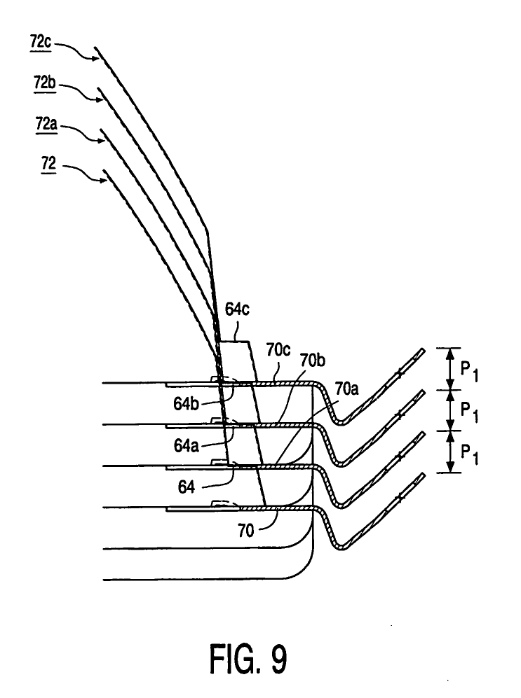

FIG. 9 schematically shows the stacking of a plurality of Internal Magnetic Shields of the FIG. 8 type; and

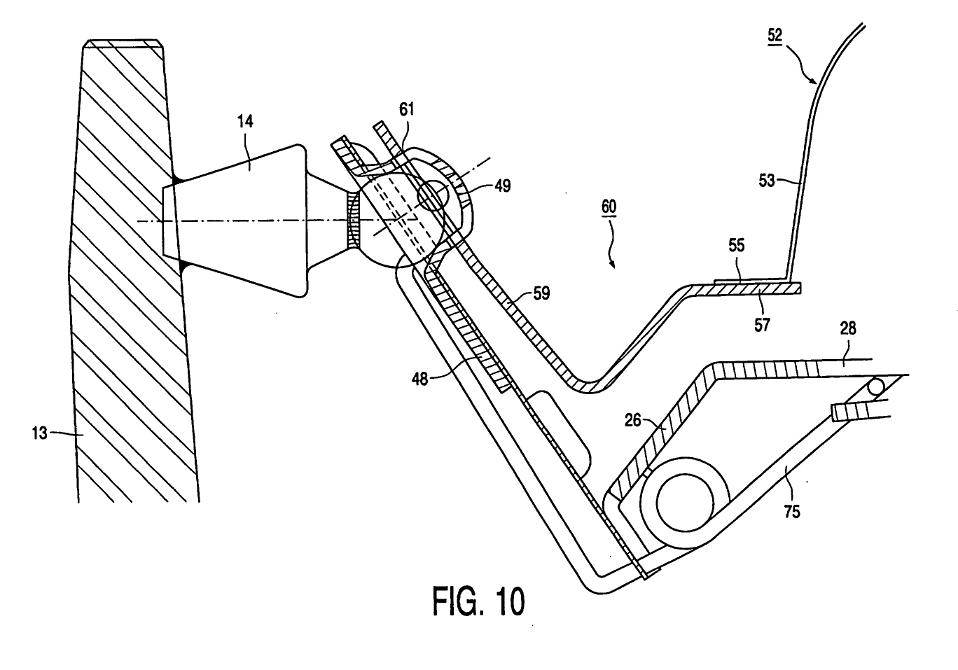

FIG. 10 is a sectional view of a frame support member and an Internal Magnetic Shield support member, mounted on a corner pin.

Referring to FIG. 1, a color display tube includes a glass vacuum envelope 10 having a neck 11, a funnel 12, a substantially rectangular face plate 15, and a skirt 13 extending between the face plate and the funnel. Mounting pins 14 embedded in the skirt adjacent the four corners of the plate serve to position the color selection electrode or shadow mask 22 with respect to the display screen 18 on the inside surface of the face plate 15. The display screen 18 is composed of a large number of red, green and blue luminescing phosphor elements which are covered with an aluminum coating 19. The elements luminesce when bombarded by electrons in the beams 21 emitted from an electron gun 20 mounted in the neck. The beams 21 are deflected by deflection coils 24, which are coaxially arranged about a longitudinal axis of the tube, and pass through apertures 23 in the mask 22 to illuminate the phosphor elements.

The mask 22 is welded to a supporting frame 25, which in turn is mounted on the pins 14. The frame 25 is provided with four corner brackets 26, each bracket 26 having a resilient plate 40 welded thereto, the plates 40 being loaded against the pins 14 to position the mask 22 and frame 25 with respect to the vacuum envelope 10. Internal Magnetic Shield 52 can be mounted in the envelope 10 in several manners, none of which is shown in this example. The shield 52 is connected to a metallic layer 27 on the inside of funnel 12 through contact springs 28.

FIG. 2 is a plan view of the mask 22 and frame 25 seen from the rear, i.e., the side opposite the display screen. In this example two long diaphragms 33 and two short diaphragms 36, all having angular cross sections, are welded to the corner brackets 26 to form a rectangle. Each of the diaphragms 33, 36 has a thickness of 0.2 mm to 0.4 mm, which closely matches the 0.2 mm thickness of the mask and assures a uniform expansion of the assembly during warm-up. The mask and diaphragms are preferably made of low carbon steel; the corner brackets, which are 0.5 to 0.8 mm thick, are either made of low carbon steel, nickel plated low carbon steel, or stainless steel. In this example the corner brackets 26 each have a rectangular hole 28 with a bent-out lip for receiving a spring means for loading the frame support members against the pins.

The resilient plates 40, which accommodate to thermal expansion and are also referred to as temperature compensation plates, are welded to respective corner brackets 26 and extend toward the viewer as cantilevers. Three of the resilient plates 40 have round holes 42 which fix their corresponding corners in the Z direction, and also fix the entire mask diaphragm assembly in the X and Y directions. The fourth resilient plate has a slot 43 which fixes its corner in the Z direction, the position in the X and Y directions being fixed by the other three plates.

FIG. 3 shows the assembly of mask and frame in greater detail. Each long diaphragm 33 is formed by a base portion 34 and an upright flange 35, which meet at a right angle. Each short diaphragm 36 is formed by a base portion 37 and an upright flange 38 which meet at a right angle. The base portions 34, 37 are welded to the base 27 of the corner bracket 26. The upright flanges 35, 38 serve as mounting means for the mask 22, which is welded thereto. Only some of the apertures 23 for directing the electron beams are shown. The resilient plate 40 is welded to the bracket 26 as shown in FIG. 4, and is provided with a round aperture 42 which is aligned for mounting against the round head of pin 14 on the skirt 13.

During manufacture, the corner brackets 26 and plates 40 are placed on an assembly block which serves as a positioning jig (not shown), and the plates are welded to the respective corner brackets. The diaphragms are then welded to the corner brackets 26, and the completed frame is removed from the assembly block. The shadow mask 22 is then welded to the flanges 35, 38, and the assembly is placed in the skirt 13, with the plates 40 being resiled so that the holes 42 and slot 43 engage respective pins 14. The assembly is now ready for screening.

Screening is a well-known process in which a photosensitive coating for each of the colors is exposed through the mask and developed. First a coating for one color of luminescing phosphors is exposed, then the mask/frame is removed and the coating is developed to leave the luminescing elements. Then a photosensitive coating for another color is coated over the elements, the mask/frame is replaced, and the coating is exposed through the mask. The mask/frame is removed and the coating developed. The process is repeated for the third color, then all of the phosphor elements are coated with a 200-500 mm thick layer of aluminum and the mask/frame is again placed on the pins 14. The internal magnetic shield 52 (FIG. 1) is then fixed to the frame by means of dart clips received through apertures 28, and the vacuum envelope 10 (FIG. 1) is sealed to the skirt and evacuated.

FIG. 4 is a plan view of an embodiment of resilient plate 46 which carries a slide plate 48 having a formed boss 49 which engages the respective pin. The slide plate 48 can move in the X-Y plane by virtue of tabs 50 received through slots 47 in the TC plate. During manufacture, the slide plates 48 are welded to the plate 46, after the diaphragms are welded to the brackets, when the frame is initially placed on pins. This assures precise alignment with the face plate, but entails additional parts.

Inner magnetic shield 52 is shown in larger detail and in perspective view in FIG. 5. Shield 52 has a cone or funnel portion 53, which at its wider end 54 is provided with a flange 55. The invention relates in particular to a shield, which has been formed by means of deep drawing. Such a shield has wrinkles 100 in its corner areas.

In the embodiment of FIG. 5, flange 55 has a skirt 56. A skirt makes a flange more rigid, but can be omitted, if desired. Flange 55 is bevelled at its diagonal corner areas A, B, C and D (not visible) which are skirtless and form the places where support members 60 have to be attached, e.g. by means of welding. The support members are attached to the lower surface of flange 55, remote from the cone portion 53.

As shown in FIG. 6, support member 60 has a base plate portion 57, which is provided with reference faces 58. These reference faces are brought into engagement with an alignment means before the support members are fixed in place.

After being attached to the flange, the base plates of the support members project inwardly into the inner space of cone portion 53.

The flat portion 57 is connected with a distal end 59 having near its free end an aperture 61 for mounting purposes. In this example the distal end 59 has been bent into a V-shape. In other embodiments the distal end may have been given alternative shapes.

If a plurality of inner magnetic shields 52, 52a, 52b, 52c . . . provided which such inwardly projecting support members is stacked, the support member (60) of a first Internal Magnetic Shield (52) may locally (at L) exert a clamping force upon the cone portion (53a) of its neighbor (52a), causing deformation, while de-stacking of inner magnetic shields which are clamped together may cause twisting, which also introduces deformation. The above stacking situation is shown schematically in FIG. 7.

To solve the above problem, an embodiment of the invention employs an inner magnetic shield 62 which has been provided with indentations (63) in its corner areas (FIG. 8). The invention utilizes the insight that the wrinkles 100 (FIG. 8) consist of “superfluous” material which advantageously can be used to form the desired, inwardly projecting, indentations. The indentations are shaped such that at their flange side they present a bearing face (64) for a support member of a second Internal Magnetic Shield which is stacked on the Internal Magnetic Shield in question.

An extra advantage is that the indentations can be formed at such positions that the stacking period is substantially reduced. A stacking period P of 25 mm (FIG. 7) may be reduced e.g. to a stacking period P₁ of 10 mm (FIG. 9). FIG. 9 schematically shows, in a cross section, the stacking of inner magnetic shields 72, 72a, 72b, 72c which have indentations in the corners of their cone portions. The indentations form bearing surfaces 64, 64a, 64b, 64c on which support members 70a, 70b, 70c rest.

FIG. 10 schematically shows, in cross-section, a resilient plate 40, which is connected to a corner bracket 26. Plate 40 is loaded, by means of spring means 75, on corner pin 14. Plate 40 is provided with a slideable plate (washer) 48, which has a dome shaped boss 49 for fixing plate 40 on the head of pin 14. It has been found to be advantageous to mount support member 60 of inner magnetic shield 52 on boss 49 by clicking distal end 59 on it by means of its aperture 61. In alternative embodiments distal end 59 can be mounted directly on pin 14.

The foregoing is exemplary and not intended to limit the scope of the claims that follow.

Mounting the Internal Magnetic Shield on the corner pins 14 by clicking the distal ends of its support members on the bosses of the slide plates used in mounting the shadow mask on the pins 14 is sometimes referred to as indirect mounting.

In a direct Internal Magnetic Shield mounting method the distal ends of the support members of the Internal Magnetic Shield engage the mounting pins 14 directly through their apertures.

Summarizing, the invention relates to a ferromagnetic shielding funnel for reception within the conical portion of a cathode ray tube having support members at the corner portions of its wider end. The support members project over a small distance into the inner space of the funnel for forming reference faces. The funnel has indentations so that, when two funnels are stacked one upon the other, the indentations in the lower funnel receive the inwardly projecting portions of the support members of the upper funnel, so that damage during and after stacking is prevented.

1. Internal Magnetic Shield for a cathode ray tube, having a cone portion with two long sides and two short sides, and a flange at the wider end of the cone portion, the flange having four corner portions, each corner portion being bevelled, a metal support member being arranged at each of said corner portions, each metal support member comprising a base plate which is attached to the side of the flange which is remote from the cone portion and a distal end having an aperture, characterized in that said base plate has a portion which projects into the inner space of the cone portion.

2. Internal Magnetic Shield as claimed in claim 1, wherein the inwardly projecting portion of at least one base plate comprises at least one reference face, said reference face extending normal to the main surface of the base plate.

3. Internal Magnetic Shield as claimed in claim 1, wherein the cone portion has four corners where the long sides and the short sides cross, an indentation being provided in each corner, each indentation having a flat bearing surface at the sides where it faces the flange, said bearing surfaces enabling the inwardly extending portions of the base plates of the support members of another Internal Magnetic Shield, if stacked on the Internal Magnetic Shield, to rest on them.

4. Internal Magnetic Shield as claimed in claim 3, wherein if another Internal Magnetic Shield is stacked on the Internal Magnetic Shield the distance between their flanges is in the range from 5 to 20 mm.

5. Cathode ray tube having an Internal Magnetic Shield as claimed in claim 1.

6. A cathode ray tube as claimed in claim 5, comprising:
a vacuum envelope having a neck, a funnel, a substantially rectangular face plate with an inside surface, a skirt extending between said face plate and said funnel, and four pins extending inward from said skirt adjacent respective corners of said face plate,
a display screen on said inside surface, said display screen comprising a plurality of phosphor elements,
an electron gun assembly arranged in said neck for emitting electrons toward said display screen,
a substantially rectangular shadow mask mounted on the pins and comprising a plurality of apertures which direct electrons toward the phosphor elements, characterized in that the distal end of each metal support member bears on a respective one of said pins.

7. A cathode ray tube as claimed in claim 6, wherein the distal end of each support member engages a respective one of said pins through its aperture.

8. A cathode ray tube as claimed in claim 6, further comprising:
a substantially rectangular supporting frame to which said shadow mask is connected, said frame comprising four corner brackets, and four resilient plates fixed directly to respective corner brackets, each plate having aperture means engaging a respective one of said pins and being spring loaded thereagainst wherein each of said aperture means comprises a floating washer, said floating washer being provided with a boss having an inner face which engages a respective one of said pins and an outer face which engages a respective one of said distal ends through its aperture.
